(19) United States
(12) Patent Application Publication
(10) Pub. No.: US 2010/0240463 A1
(43) Pub. Date: Sep. 23, 2010

(54) Shaft coupling

(75) Inventors: Peter Horling, Schonungen (DE); Wolfgang Glantz, Schweinfurt (DE)

Correspondence Address: Mark A. Ussai;SKF USA Inc., 890 Forty Foot Road, PO Box 332, Kulpsville, PA, 19443, US

(73) Assignee: Aktiebolaget SKF, Goteborg (SE)

(21) Appl. No.: 12/658,352

(22) Filed: Feb. 5, 2010

(30) Foreign Application Priority Data
Feb. 2, 2009 (DE) 10 2009 007 993.9

(51) Int. Cl. F16C 3/00

(52) U.S. Cl. 464/162

(57) ABSTRACT

A rigid torque-transmitting coupling includes two members and a coating on one member or on carrier disposed between the members. The carrier has opposing contact faces disposed against a separate member connection face. The coating includes a fixing layer disposed on the connection member face or one carrier face, and a plurality of particles are disposed within the fixing layer to secure the particles on the member or carrier. Each particle has a hardness of at least 9 on the Mohs scale and at least twenty-five percent of the particles within any area of the coating extend outwardly from the fixing layer outer surface. Further, each member contacts either the other member or the coating carrier with a pressure of about 90 MPa and 180 MPa. The surface(s) carrying the coating are formed of a harder material than the member faces engaged by the coating.

The present application claims priority to German Patent Application No. 10 2009 007 993.9 filed on Feb. 2, 2009, the contents of which are fully incorporated herein by reference.

The invention relates to a rigid torque-transmitting connection, and more particularly to such a connection between two shaft members.

Connections or couplings between two members, such as shaft elements, are generally known and include some means for connecting end surfaces of each element.

### SUMMARY OF THE INVENTION

An object of the invention, therefore, is to provide an improved rigid torque-transmitting connection, by means of which, in particular, high static friction coefficients can be achieved.

In one aspect, the present invention is a rigid torque-transmitting coupling comprising two members each having a connection face and either a coating disposed on one of the member connection faces or a coating carrier disposed between the two members. The coating carrier has opposing contact faces, each contact face being disposed against a separate one of the member connection faces, and at least one contact face having a coating. The coating includes a fixing layer disposed on the connection member face or one of the carrier contact faces, and a plurality of particles are disposed at least partially within the fixing layer so as to secure the particles on the member connection face or the carrier contact face. Each particle has a hardness of at least 9 on the Mohs hardness scale and at least twenty-five percent of the plurality of particles within any unit area of the coating extend outwardly from an outer surface of the fixing layer. Further, the two members are connected together such that each member contacts either the other member or the coating carrier with a pressure, the pressure having a value within a range of about 90 MPa and 180 MPa. Furthermore, each member connection face in contact with the coating is formed of a first material and the member connection face carrying the coating or the at least one carrier contact face having the coating is formed of a second material, the second material having a substantially greater hardness than the first material.

Consequently, especially advantageously, a connection is provided in which static friction coefficients greater than 0.7 and even above 0.8 can be achieved, which has not been possible hitherto to implement.

In an advantageous refinement, the fixing layer is formed from nickel applied by electroplating, so that, for example, at the same time an excellent protective layer against corrosion-causing and other environmental influences is generated for the coating carrier.

In an advantageous refinement, the coating carrier is designed with a greater Mohs hardness and/or a greater tensile strength than the connection partners, so that, as desired, when they are pressed against one another, those regions of the particles which project above the coating press into the connection partners, and the coating beneath the particles and the region of the coating carrier beneath the particles are deformed only insignificantly, as compared with pressing into the connection partners.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 shows, in the form of a detail, a longitudinal section through a rigid shaft coupling of two shaft elements with a structural element resembling a perforated disc between the two flange-like shaft ends; and

FIG. 2 shows a front view of the structural element resembling a perforated disc from FIG. 1, on which a coating is applied.

### DETAILED DESCRIPTION OF THE INVENTION

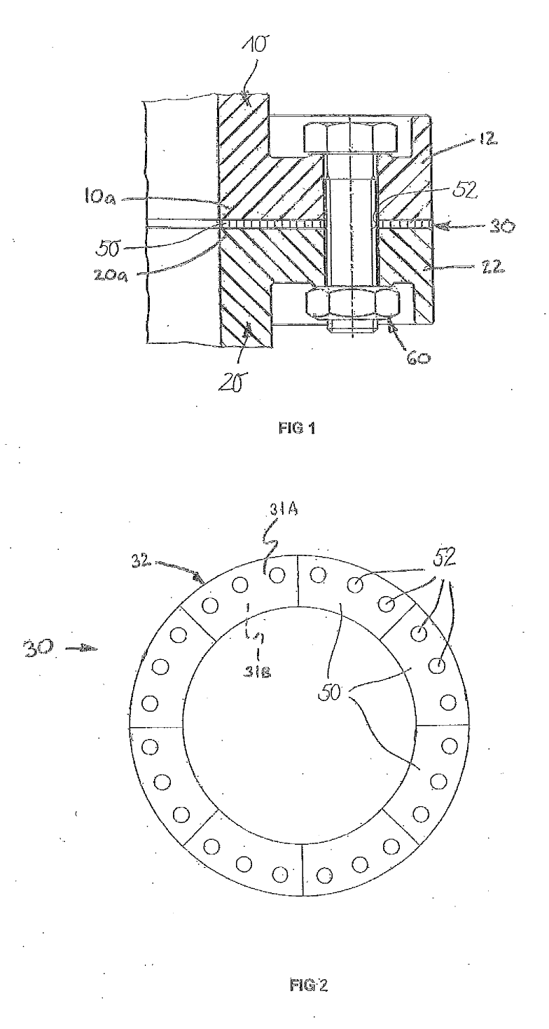

FIG. 1 shows, as an exemplary embodiment of the invention, a longitudinal section through a rigid coupling 1 comprising two members, preferably two shaft elements 10, 20 which are connectable to form a hollow shaft, such as for example, a main shaft of a wind power plant. Each of the two shaft elements 10, 20 have a shaft end 10a, 20a, respectively, that is widened in a flange-like manner, i.e., each shaft element has a flange 12, 22, respectively, the two flanges 12, 22 being connectable together. Preferably, a coating carrier 30 is disposed between the two flanges 12, 22 and is provided with a coating on at least one end face or surface 31A, 31B. Further, the carrier 30 is preferably formed as a structural element resembling a perforated disc, e.g., as a generally annular disc 32, which may include, or be divided into, a plurality of sector-like subelements 50. Each element 50 preferably has a plurality of, through-holes 52, most preferably three holes 52, as shown in FIG. 2. Preferably, each of the flanges 12, 22 of the two shaft elements 10, 20 includes corresponding openings (e.g., through-holes or blind holes) alignable with the carrier holes 52, and a plurality of fasteners 60 (only one shown) preferably extend between the two shaft elements 10, 20 and through the carrier openings 52 so as to connect the shaft elements 10, 12. The carrier 30 may include a “coding means”, for example teeth formed on the outer circumference of the disc 32, which may be used to detect shaft rotational speed.

At least one and preferably both axial end surfaces 31A, 31B of the carrier 30 are provided with the coating to ensure a firm connection between the shaft ends, and thus the two shaft elements 10, 12. The carrier disc 32 is preferably formed of a steel having a tensile strength with a range of about 600 MPa and 800 MPa. The end-face surfaces 31A, 31B of the coating carrier 30 are preferably ground to a surface roughness of Ra≦0.2 μm. Further, the grinding process preferably creates furrow-like depressions with a depth of less than or equal to 4 μm and with a width of less than or equal to 6 μm, and most preferably, the depressions have a depth of less than approximately ten percent (10%) of the coating thickness and/or with a width of less than approximately fifteen percent (15%) of the coating thickness. By providing depressions of such dimensions, the furrow-like depressions ensure optimal adhesion of the coating while reducing the chance that any coating particles disposed within the depressions do not extend above the fixing layer outer surface.

The coating preferably includes an undercoating formed of nickel with a thickness of, for example, approximately 5 μm, which is applied by electroplating to at least one and preferably both ground faces 31A, 31B of the coating carrier 30. A plurality of particles with a hardness of at least 9 on the Mohs scale, and most preferably a Mohs hardness of 10, and a grain size of between 40 μm and 90 μm, are disposed on the undercoating layer in a substantially single layer, but may form a plurality of layers. Preferably, each particle is provided by a sharp-edged or block-like grain of a monocrystalline diamond, for example of a natural diamond. Then, an overcoating of nickel is applied, preferably by electroplating, so that at least a lower region of the particles (i.e., the ends of the particles proximal to the contact surface) on the undercoating are surrounded by the overcoating. Thereby, the particles are fixed or secured in a substantially single layer, and if a plurality of layers have been applied to the undercoating, the outer, excess layers are removed, for example, by brushing after fixing/securing the particle layer with the overcoating.

As used herein, the term “a substantially single layer” is intended to mean that, in a predominant fraction of the coating, preferably greater than 75%, is actually one layer of particles, and in the remainder of the coating the particles may be adhered in multiple layers, particularly in two layers. Consequently, the coating is formed with more than 25% or even up to 40% of the particles projecting out of, or extending outwardly from, the outer surface of the nickel “fixing” layer, with the result that, ultimately, very high static friction coefficients can be achieved.

As mentioned above, both of the end faces or surfaces 31A, 31B of the coating carrier 30 are preferably provided with the coating as described in detail above. The flanges 12, 22 of the two shaft elements 10, 20 are preferably formed of a first material and the carrier faces 31A, 31B are formed of a second material, the second material having a substantially greater hardness than the first material, both in terms of Mohs hardness and tensile strength. Preferably, the shaft flanges 12, 22 are each formed of a grey cast iron, for example GG 40.3 with a tensile strength in the range of between 400 and 500 MPa. Each flange 12, 22 has a connection surface or face 13, 23, respectively, disposeable against or contactable with the carrier 30, each face 13, 23 preferably having a roughness Ra in the range of between 0.5 μm and 1.5 μm.

When the carrier 30 is disposed between the two shaft ends 10a, 20a and the flanges 12, 22 are fastened together, the diamond particles press into the grey cast iron during fastening such that the carrier 30 is connected inter-engagingly with the shaft ends 10a, 20a. Specifically, the two shaft ends 10a, 20a are preferably pressed against one another with a pressure per unit area of about 90 MPa to about 180 MPa. In other words, each shaft element 10, 20 contacts the coating carrier 30 with a pressure having a value within a range of about 90 MPa and 180 MPa. During fastening, the undercoating layer beneath the diamond particles is only slightly compressed in the direction of the carrier 30.

With this structure, the static friction coefficients between the shaft ends 10a, 20a and the carrier 30 greater than 0.7, and preferably greater than 0.8,are present within the coupling. Furthermore, the nickel undercoating provides excellent corrosion protection for the steel coating carrier 30, so that the carrier disc 32 is protected reliably against the most adverse climatic conditions. As a further result, with a connection having the above-described coating, the number of required fasteners can be reduced in comparison with conventional connections, while the strength of the connection remains the same.

Although the coupling is primarily shown and described as including the disc-like coating carrier 30, with the coating being applied to at least one and preferably both contact faces of the carrier 30, the coupling may alternatively be constructed without the carrier and instead have the coating, as described above, applied to the connection face of one of the two shaft elements 10 or 20.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A rigid torque-transmitting coupling comprising:
two members each having a connection face;
one of a coating disposed on one of the member connection faces and a coating carrier disposed between the two members and having opposing contact faces, each contact face being disposed against a separate one of the member connection faces and at least one contact face having a coating;
wherein the coating includes a fixing layer disposed on the one of the member connection face and one of the carrier contact faces and a plurality of particles disposed at least partially within the fixing layer so as to secure the particles on the one of the member connection face and the carrier contact face, each particle having a hardness of at least 9 on the Mohs hardness scale, at least twenty-five percent of the plurality of particles within any unit area of the coating extending outwardly from an outer surface of the fixing layer;
wherein the two members are connected together such that each member contacts one of the other member and the coating carrier with a pressure, the pressure having a value within a range of about 90 MPa and 180 MPa; and
wherein each member connection face in contact with the coating being formed of a first material and the one of the member connection face carrying the coating and the at least one carrier contact face having the coating being formed of a second material, the second material having a substantially greater hardness than the first material

2. The coupling as recited in claim 1 wherein torque is transmitted between the two members through the carrier.

3. The coupling as recited in claim 1 wherein the coating carrier is formed from a steel having a tensile strength within a range of about 600 MPa and about 800 MPa.

4. The coupling as recited in claim 1 wherein the coating carrier includes an annular disc.

5. The coupling as recited in claim 4 wherein the coating carrier disc includes a plurality of sector-like subelements.

6. The coupling as recited in claim 1 wherein the coating carrier has a plurality of openings and the coupling further comprises a plurality of fasteners, each fastener extending between the two members and through a separate one of the carrier openings.

7. The coupling as recited in claim 1 wherein each of the two members is a shaft element.

8. The coupling as recited in claim 1 wherein the coating carrier has a coding means for detecting shaft rotational speed.

9. The coupling as recited in claim 1 wherein at least one of the two members is formed of grey cast iron with a tensile strength within a range of about 400 MPa and about 500 MPa.

10. The coupling as recited in claim 1 wherein at least one of the two members has at least one of a hardness lesser than a hardness of the coating carrier and a tensile strength lesser than a tensile strength of the coating carrier.

11. The coupling as recited in claim 1 wherein each of the coating particles has a particle size within a range of about 40 μm and 90 μm.

12. The coupling as recited in claim 1 wherein each of the coating particles is formed of monocrystalline diamond.

13. The coupling as recited in claim 1 wherein the one of the member connection face having the coating and the at least one carrier surface having the coating is ground prior to applying the coating so as to form a plurality of depressions.

14. The coupling as recited in claim 13 wherein at least eighty-five percent of the depressions have at least one of a depth of less then approximately ten percent of the coating thickness and a width of less then fifteen percent of the coating thickness.

15. The coupling as recited in claim 13 wherein each of the depression is formed having a depth of less than or equal to 6 μm and a width of less than about 8 μm.

16. The coupling as recited in claim 1 wherein the one of the member connection face having the coating and the at least one carrier surface having the coating is ground to a roughness of Ra≦0.2 μm prior to applying the coating.

17. The coupling as recited in claim 1 wherein the coating fixing layer includes a metallic material applied by electroplating.

18. The coupling as recited in claim 1 wherein the coating particles are arranged substantially in a single layer.

19. The coupling as recited in claim 1, wherein the coating further includes an undercoating layer disposed between the fixing layer and the one of the member connection face having the coating and the at least one carrier surface having the coating.

20. A rigid torque-transmitting coupling comprising:
two members each having a connection face;
a coating carrier disposed between the two members and having opposing contact faces, each contact face being disposed against a separate one of the member connection faces;
a coating disposed on at least one of the carrier contact faces and including a fixing layer disposed on the contact face and a plurality of particles disposed at least partially within the fixing layer so as to secure the particles on the one of the member connection face and the carrier contact face, each particle having a hardness of at least 9 on the Mohs hardness scale, at least twenty-five percent of the plurality of particles within any unit area of the coating extending outwardly from an outer surface of the fixing layer;
wherein the two members are connected together such that each member contacts the coating carrier with a pressure, the pressure having a value within a range of about 90 MPa and 180 MPa; and
wherein each member connection face in contact with the coating is formed of a first material and the at least one carrier contact face having the coating is formed of a second material, the second material having a substantially greater hardness than the first material.
